(19) United States
(12) Patent Application Publication
(10) Pub. No.: US 2025/0191201 A1
(43) Pub. Date: Jun. 12, 2025

(54) APPARATUS FOR TRACKING OBJECT AND METHOD THEREOF

(71) Applicants: Hyundai Motor Company, Seoul (KR); Kia Corporation, Seoul (KR)

(72) Inventors: Min Jung KIM, Hwaseong-si (KR); Hyun Kyu LIM, Hwaseong-Si (KR); Jae Won KEY, Hwaseong-si (KR)

(73) Assignees: Hyundai Motor Company, Seoul (KR); Kia Corporation, Seoul (KR)

(21) Appl. No.: 18/895,120

(22) Filed: Sep. 24, 2024

(30) Foreign Application Priority Data
Dec. 12, 2023 (KR) 10-2023-0180170

(51) Int. Cl. G06T 7/277

(52) U.S. Cl. CPC G06T 7/277; G06T 2207/30241

(57) ABSTRACT

In an object tracking apparatus and a method therefor, the object tracking apparatus includes: a processor configured for estimating a state variable of an object for each time point in a first direction in a flow of time, and to estimate the state variable for each time point in a second direction which is opposite to the first direction, and configured for estimating the state variable of the object in the second direction for each time point using a result value estimated in the first direction; and a storage configured to store data and algorithms driven by the processor.

### CROSS-REFERENCE TO RELATED APPLICATION

The present application claims priority to Korean Patent Application No. 10-2023-0180170, filed on Dec. 12, 2023, the entire contents of which is incorporated herein for all purposes by this reference.

### BACKGROUND OF THE PRESENT DISCLOSURE

### Field of the Present Disclosure

The present disclosure relates to an object tracking apparatus and a method therefor, and more particularly, to a technique for improving object tracking performance using bidirectional tracking.

### Description of Related Art

With development of artificial intelligence technology, technology to recognize and track objects through image processing is being used in various fields.

A demand for models that can recognize and track objects in autonomous vehicles, security monitoring devices, etc. is increasing.

An object tracking technique is being developed to recognize objects in images and track them. Object tracking refers to a computer vision technique that finds changes in position of specific objects such as people, animals, and vehicles in images captured by a camera.

Conventionally, an algorithm called Kalman Filter is used to track such objects.

However, the conventional Kalman filter is a one-way Kalman filter, and has limitations in terms of accuracy and reliability because it estimates a state using information from a specific time point and a next time point.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object tracking apparatus and a method therefor, configured for improving object tracking performance by performing bidirectional tracking over time in response to recognizing an object.

An exemplary embodiment of the present disclosure attempts to provide an object tracking apparatus and a method therefor, configured for ameliorating an error during forward tracking by applying a two-way Kalman filter forward from a time point t−1 to a time point t+1 and backward from the time point t+1 to the time point t−1, and using a forward tracking result during backward tracking, improving object tracking performance.

An exemplary embodiment of the present disclosure attempts to provide an object tracking apparatus and a method therefor, configured for outputting a final object tracking result by applying a forward tracking result and a bidirectional tracking result to a deep learning algorithm, improving object tracking performance.

The technical objects of the present disclosure are not limited to the objects mentioned above, and other technical objects not mentioned may be clearly understood by those skilled in the art from the description of the claims.

An exemplary embodiment of the present disclosure provides an object tracking apparatus including: a processor configured for estimating a state variable of an object for each time point in a first direction in a flow of time, and to estimate the state variable for each time point in a second direction which is opposite to the first direction, and configured for estimating the state variable of the object in the second direction for each time point using a result value estimated in the first direction; and a storage configured to store data and algorithms driven by the processor.

In an exemplary embodiment of the present disclosure, the processor may be configured for estimating the state variable of the object at a second time point using the state variable of the object at a first time point and a sensor measurement value at the first time point in response to the estimating the state variable of the object in the first direction, and to estimate the state variable of the object at the first time point in the second direction using the state variable of the object at the second time point and the state variable of the object at the first time point estimated in the first direction in response to the estimating the state variable of the object in the second direction.

In an exemplary embodiment of the present disclosure, the first direction may include a forward direction from a previous time to a future time in the flow of time, and the second direction may include a backward direction from the future time to the previous time in the flow of time.

In an exemplary embodiment of the present disclosure, the processor may be configured for estimating a forward state variable at a second time point using the forward state variable at the first time point and the sensor measurement value at the first time point,
to estimate the forward state variable at a third time point using the forward state variable at the second time point and the sensor measurement value at the second time point, to estimate the backward state variable at the second time point using the forward state variable at the third time point and the forward state variable at the second time point, and to estimate the backward state variable at the first time point using the backward state variable at the second time point and the forward state variable at the first time point.

In an exemplary embodiment of the present disclosure, the processor may be configured to input the forward state variable at the first time point into a motion model to predict the forward state variable at the second time point, and to update the forward state variable at the second time point using a Kalman gain and the sensor measurement value at the second time point.

In an exemplary embodiment of the present disclosure, the processor may be configured for estimating an error covariance for each time point in the first direction in the flow of time, and to estimate the error covariance for each time point in the second direction which is opposite to the first direction.

In an exemplary embodiment of the present disclosure, the processor may be configured for estimating the error covariance at the second time point using the error covariance at the first time point and a system noise, and to update the error covariance at the second time point using the Kalman gain.

In an exemplary embodiment of the present disclosure, the processor may be configured to determine a weight by applying an input value obtained in the first direction and an input value obtained in the second direction to a deep learning algorithm.

In an exemplary embodiment of the present disclosure, the input value obtained in the first direction and the input value obtained in the second direction may include at least one of a state variable of the object, error void, noise, sensor predictor variable, or a combination thereof.

In an exemplary embodiment of the present disclosure, the processor may be configured to determine an output value in the first direction using the state variable of the object obtained in the first direction, and to determine the output value in the second direction using the state variable of the object obtained in the second direction.

In an exemplary embodiment of the present disclosure, the processor may be configured to determine a final output value by reflecting a weight on the output value in the first direction and the output value in the second direction.

In an exemplary embodiment of the present disclosure, the processor may be configured to compare the final output value with a previously known correct answer to receive feedback on a difference therebetween.

In an exemplary embodiment of the present disclosure, the processor may be configured to determine whether both the sensor measurement value obtained in the first direction and the sensor measurement value obtained in the second direction among the input value obtained in the first direction and the input value obtained in the second direction are input, and

in response that at least one of the sensor measurement value obtained in the first direction or the sensor measurement value obtained in the second direction is not input, to determine whether the sensor measurement value obtained in the first direction has been input.

In an exemplary embodiment of the present disclosure, the processor may be configured to set the weight to 1 in response that the sensor measurement value obtained in the first direction is input, and to set the weight to 0 in response that the sensor measurement value obtained in the first direction is not input.

In an exemplary embodiment of the present disclosure, the processor may be configured in response that both the sensor measurement value obtained in the first direction and the sensor measurement value obtained in the second direction are input, to determine whether a difference between the state variable obtained in the first direction and the state variable obtained in the second direction among the input value obtained in the first direction and the input value obtained in the second direction is greater than a predetermined threshold.

In an exemplary embodiment of the present disclosure, the processor may be configured to set the weight to 1 in response that the difference between the state variable obtained in the first direction and the state variable obtained in the second direction is smaller than or equal to the predetermined threshold.

In an exemplary embodiment of the present disclosure, the processor may be configured, in response that the difference between the state variable obtained in the first direction and the state variable obtained in the second direction is greater than the predetermined threshold, to determine whether the error covariance obtained in the first direction between the input value obtained in the first direction and the input value obtained in the second direction is smaller than the error covariance obtained in the second direction.

In an exemplary embodiment of the present disclosure, the processor may be configured to set the weight to 0.5 or more than 0.5 in response that the error covariance obtained in the first direction is smaller than the error covariance obtained in the second direction, and to the weight to less than 0.5 in response that the error covariance obtained in the first direction is greater than or equal to the error covariance obtained in the second direction.

An exemplary embodiment of the present disclosure provides an object tracking method including: estimating, by a processor, a state variable of an object for each time point in a first direction in a flow of time; and estimating, by the processor, the state variable for each time point in a second direction which is opposite to the first direction, and estimating the state variable of the object in the second direction for each time point using a result value estimated in the first direction

In an exemplary embodiment of the present disclosure, it may further include: determining, by the processor, a weight by applying an input value obtained in the first direction and an input value obtained in the second direction to a deep learning algorithm; determining, by the processor, an output value in the first direction using the state variable of the object obtained in the first direction; determining, by the processor, the output value in the second direction using the state variable of the object obtained in the second direction; and determining, by the processor, a final output value by reflecting a weight on the output value in the first direction and the output value in the second direction.

According to an exemplary embodiment of the present disclosure, it may be possible to improve object tracking performance by performing bidirectional tracking over time in response to tracking objects.

According to an exemplary embodiment of the present disclosure, it may be possible to ameliorate an error during forward tracking by applying a two-way Kalman filter forward from a time point t−1 to a time point t+1 and backward from the time point t+1 to the time point t−1, and using a forward tracking result during backward tracking, improving object tracking performance.

According to an exemplary embodiment of the present disclosure, it may be possible to output a final object tracking result by applying a forward tracking result and a bidirectional tracking result to a deep learning algorithm, improving object tracking performance.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing a configuration of an example vehicle system including an object tracking apparatus.

FIG. 2 illustrates a view for describing an example basic process of estimating a state variable and an error covariance using a Kalman filter.

FIG. 3 illustrates a view for describing an example bidirectional state variable tracking process.

FIG. 4 illustrates a view for describing an example forward object tracking process in detail.

FIG. 5 illustrates a view for describing an example backward object tracking process in detail.

FIG. 6 illustrates a view for describing an example of performing compensation through backward tracking in response that a sensor measurement value is missing while forward tracking is performed during object tracking.

FIG. 7 illustrates a view for describing an example process of determining a final object tracking output value using a bidirectional tracking result.

FIG. 8 illustrates a flowchart for describing an example method of determining a final object tracking output value using a bidirectional tracking result.

FIG. 9 illustrates an example computing system.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. In describing an exemplary embodiment of the present disclosure, when it is determined that a detailed description of the well-known configuration or function associated with the exemplary embodiment of the present disclosure may obscure the gist of the present disclosure, it will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field of the present disclosure to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

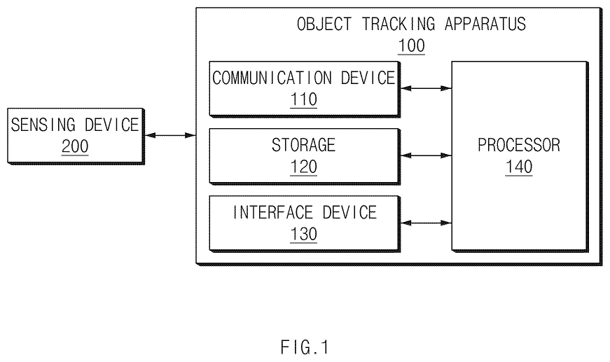

Hereinafter, various exemplary embodiments of the present disclosure will be described in detail with reference to FIG. 1 to FIG. 9.

FIG. 1 illustrates a block diagram showing a configuration of an example vehicle system including an object tracking apparatus.

Referring to FIG. 1, a vehicle system according to an exemplary embodiment of the present disclosure may include an object tracking apparatus 100 and a sensing device 200.

The object tracking apparatus 100 according to an exemplary embodiment of the present disclosure may be implemented inside or outside the vehicle. In the instant case, the object tacking apparatus 100 may be integrally formed with internal control units of the vehicle, or may be implemented as a separate hardware device to be connected to control units of the vehicle by a connection means. For example, the object tracking apparatus 100 may be implemented integrally with the vehicle, may be implemented in a form which is installed or attached to the vehicle as a configuration separate from the vehicle, or a part thereof may be implemented integrally with the vehicle, and another part may be implemented in a form which is installed or attached to the vehicle as a configuration separate from the vehicle.

In response to detecting an object from output values of cameras, LiDAR, radio detection and ranging (RADAR), etc., the object tracking apparatus 100 may be configured to track the object by applying the Kalman filter algorithm, and to improve object tracking performance through bidirectional tracking by tracking the object in the forward direction and then tracking the object in the backward direction. In the instant case, the object tracking apparatus 100 may be configured to improve object tracking performance through backward tracking even in a case where there is information missing during forward tracking by use of the results of forward tracking instead of sensor measurement values during backward tracking.

The object tracking apparatus 100 may include a communication device 110, a storage 120, an interface device 130, and a processor 140. According to an exemplary embodiment of the present disclosure, the object tracking apparatus 100 may be implemented as a single unit by coupling components with each other, and some components may be omitted.

The communication device 110 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include Controller Area Network (CAN) communication, Local Interconnect Network (LIN) communication, flex-ray communication, and the like.

Furthermore, the communication device 110 may perform communication with a server, infrastructure, or third vehicles outside the vehicle, and the like through a wireless communication technique, a short range communication technique, or a mobile communication technique.

Herein, the wireless Internet communication may include (WLAN), wireless-fidelity (Wi-Fi), Wi-Fi direct, Digital Living Network Alliance (DLNA), Wireless Broadband (WiBro), Worldwide Interoperability for Microwave Access (WiMAX), Predetermined Speed Downlink Packet Access (HSDPA), High Speed Uplink Packet Access (HSUPA), Long Term Evolution (LTE), Long Term Evolution-Advanced (LTE-A), or the like. Furthermore, the short-range communication technique may include at least one of Bluetooth™, Radio Frequency Identification (RFID), Infrared Data Association (IrDA), ultra wideband (UWB), ZigBee, Near Field Communication (NFC), a Wireless Universal Serial Bus (USB) technique, or any combination thereof.

The mobile communication technique may include technical standards, communication methods for mobile communication (e.g., Global System for Mobile communication (GSM), Code Division Multi Access (CDMA), code division multi access 2000 (CDMA 2000), enhanced voice-data optimized or enhanced voice-data only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), 4th generation mobile telecommunication (4G), 5th generation mobile telecommunication (5G)), or the like.

The storage 120 may store detecting results and the sensing device 200 and data and/or algorithms required for the processor 140 to operate, and the like.

For example, the storage 120 may store an algorithm for bidirectional tracking, an algorithm for determining a final output value, etc. For example, the storage 120 may store a deep learning model for determining the final output value. Furthermore, the storage 120 may store a threshold value for determining a weight value for determining the final output value.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), a human machine interface (HMI).

The output device may include a display, and may also include a voice output means such as a speaker. In the instant case, in a response to a case that a touch sensor formed of a touch film, a touch sheet, or a touch pad is provided on the display, the display may operate as a touch screen, and may be implemented in a form in which an input device and an output device are integrated. In an exemplary embodiment of the present disclosure, the output device may output an object tracking result.

In the instant case, the display may include at least one of a liquid crystal display (LCD), a thin film transistor liquid crystal display (TFT LCD), an organic light-emitting diode display (OLED display), a flexible display, a field emission display (FED), and a 3D display.

The processor 140 may be electrically connected to the communication device 110, the storage 120, the interface device 130, and the like, may electrically control each component, and may be an electrical circuit that executes software commands, performing various data processing and calculations described below.

The processor 140 may be configured to process signals transmitted between each component of the object tracking apparatus 100 and to perform overall control so that each component may normally perform its function. The processor 140 may be implemented in a form of hardware, software, or a combination of and software. For example, the processor 140 may be implemented as a microprocessor, but the present disclosure is not limited thereto. For example, it may be, e.g., an electronic control unit (ECU), a micro controller unit (MCU), or other subcontrollers mounted in the vehicle.

The processor 140 may be configured for estimating a state variable of an object for each time point in a first direction (e.g., forward direction) in a flow of time, and to estimate the state variable for each time point in a second direction (e.g., backward direction) which is opposite to the first direction, and may be configured for estimating the state variable of the object in the second direction for each time point using a result value estimated in the first direction.

In response to the estimating the state variable of the object in the first direction, the processor 140 may be configured for estimating the state variable of the object at a second time point t−1 using the state variable of the object at a first time point t−2 and a sensor measurement value at the first time point t−1.

In response to the estimating the state variable of the object in the second direction, the processor 140 may be configured for estimating the state variable of the object at the first time point t−2 in the second direction using the state variable of the object at the second time point t−1 and the state variable of the object at the first time point t−2 estimated in the first direction.

The first direction may include a forward direction from a previous time to a future time in the flow of time, and the second direction may include a backward direction from the future time to the previous time in the flow of time.

The processor 140 may be configured for estimating a forward state variable at a second time point using the forward state variable at the first time point and the sensor measurement value at the first time point, to estimate the forward state variable at a third time point using the forward state variable at the second time point and the sensor measurement value at the second time point, to estimate the backward state variable at the second time point using the forward state variable at the third time point and the forward state variable at the second time point, and to estimate the backward state variable at the first time point using the backward state variable at the second time point and the forward state variable at the first time point.

The processor 140 may be configured to input the forward state variable at the first time point into the motion model to predict the forward state variable at the second time point, and to update the forward state variable at the second time point using the Kalman gain and the sensor measurement value at the second time point.

The processor 140 may be configured for estimating an error covariance for each time point in the first direction in the flow of time for object tracking, and to estimate the error covariance for each time point in the second direction which is opposite to the first direction.

The processor 140 may be configured for estimating the error covariance at the second time point using the error covariance at the first time point and a system noise, and to update the error covariance at the second time point using the Kalman gain.

The processor 140 may be configured to determine a weight by applying an input value obtained in the first direction and an input value obtained in the second direction to a deep learning algorithm.

In the processor 140, the input value obtained in the first direction and the input value obtained in the second direction may include at least one of a state variable of the object, error void, noise, sensor predictor variable, or a combination thereof.

The processor 140 may be configured to determine an output value in the first direction using the state variable of the object obtained in the first direction, and to determine the output value in the second direction using the state variable of the object obtained in the second direction.

The processor 140 may be configured to determine a final output value by reflecting the weight on the output value in the first direction and the output value in the second direction.

The processor 140 may be configured to compare the final output value with a previously known correct answer to receive feedback on a difference between the final output value and the previously known correct answer. Accordingly, the processor 140 may be configured to determine the weight using the difference.

The processor 140 may be configured to determine whether both the sensor measurement value obtained in the first direction and the sensor measurement value obtained in the second direction among the input value obtained in the first direction and the input value obtained in the second direction are input, and to determine whether the sensor measurement value obtained in the first direction has been input in response that at least one of the sensor measurement value obtained in the first direction or the sensor measurement value obtained in the second direction is not input.

The processor 140 may be configured to set the weight to 1 in response that the sensor measurement value obtained in the first direction is input, and to set the weight to 0 in response that the sensor measurement value obtained in the first direction is not input.

In response that both the sensor measurement value obtained in the first direction and the sensor measurement value obtained in the second direction are input, the processor 140 may be configured to determine whether a difference between the state variable obtained in the first direction and the state variable obtained in the second direction among the input value obtained in the first direction and the input value obtained in the second direction is greater than a predetermined threshold.

The processor 140 may be configured to set the weight to 1 in response that the difference between the state variable obtained in the first direction and the state variable obtained in the second direction is smaller than or equal to the predetermined threshold.

In response that the difference between the state variable obtained in the first direction and the state variable obtained in the second direction is greater than the predetermined threshold, the processor 140 may be configured to determine whether the error covariance obtained in the first direction between the input value obtained in the first direction and the input value obtained in the second direction is smaller than the error covariance obtained in the second direction.

The processor 140 may be configured to set the weight to 0.5 or more than 0.5 in response that the error covariance obtained in the first direction is smaller than the error covariance obtained in the second direction, and to the weight to less than 0.5 in response that the error covariance obtained in the first direction is greater than or equal to the error covariance obtained in the second direction.

The sensing device 200 may include one or more sensors that detect an object, e.g., a preceding vehicle, positioned inside the vehicle or outside the vehicle and measure a distance with the obstacle and/or a relative speed thereof, and may transmit the results to object tracking apparatus 100.

The sensing device 200 may include a plurality of sensors to detect an external object of the vehicle, to obtain information related to a position of the external object, a speed of the external object, a moving direction of the external object, and/or a type of the external object (e.g., vehicles, pedestrians, bicycles or motorcycles, etc.). To the present end, the sensing device 200 may include an ultrasonic sensor, a radio detection and ranging (RADAR), a camera, a laser scanner, and/or a corner radio detection and ranging (RADAR), a Light Detection and Ranging (LiDAR), an acceleration sensor, a yaw rate sensor, a torque measurement sensor and/or a wheel speed sensor, a steering angle sensor, a global position system, etc.

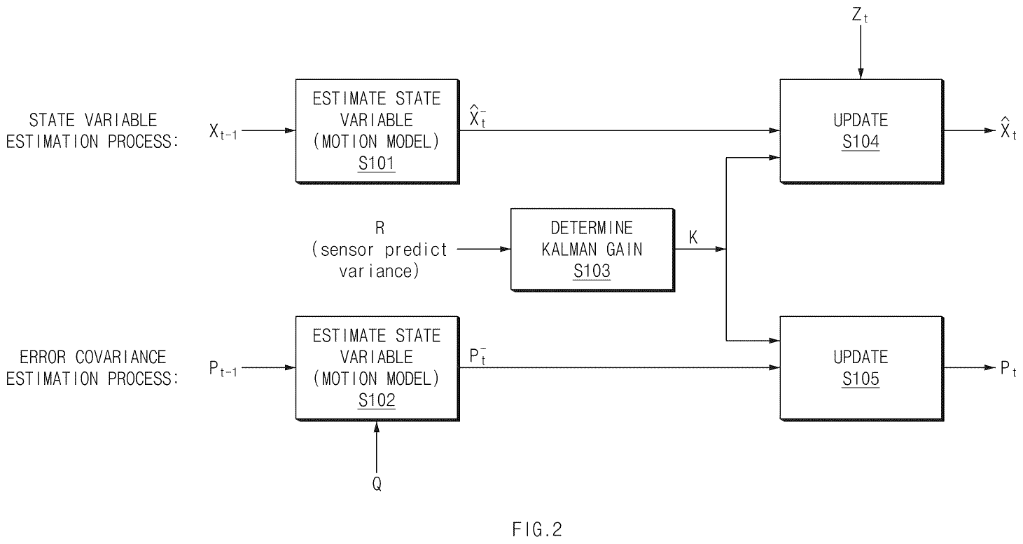

FIG. 2 illustrates a view for describing an example basic process of estimating a state variable and an error covariance using a Kalman filter.

The object tracking apparatus 100 may be configured for estimating a state variable \hat{X}ₜ and an error covariance \hat{P}ₜ using the Kalman filter. The Kalman filter is a recursive filter that estimates a state of a linear dynamical system based on measurements containing noise, and is an adaptive filter. That is, the Kalman filter updates coordinates of t using a motion model defined at a position of a time point t−1 (immediately before) and a sensor measurement value at a time point t.

To be described in detail with reference to FIG. 2, the object tracking apparatus 100 may be configured to select initial values for state variable estimation and error covariance estimation. In the instant case, the initial value for state variable estimation may be the state variable initial value Xₜ₋₁ and the error covariance initial value Pₜ₋₁. Such state variable initial value Xₜ₋₁ or error covariance initial value Pₜ₋₁ may be an initial value, a variable state value, or an error covariance value determined in a previous process.

In the instant case, the state variable may be state information of the object to be estimated, and may indicate position information, speed information, etc. of the object. Furthermore, the error covariance may be used as a measure of how accurate the state variable forecasts are.

Accordingly, the object tracking apparatus 100 may be configured to predict the state variable at the time point t by applying the initial value Xₜ₋₁ of the state variable at the time point t−1 to a motion model (S101), and to output the estimated state variable value \hat{X}ₜ⁻. In the instant case, the motion model is a model that predicts movement (position, speed, etc.) through input values.

Furthermore, the object tracking apparatus 100 may be configured to predict the error covariance at the time point t using the initial error covariance value Pₜ₋₁ and a system noise Q at the time point t−1, and to output an error covariance estimate Pₜ⁻ (S102). In the instant case, the system noise Q may be a noise that affects state variables flowing from the system, and may be a predetermined value. In the instant case, a superscript “−” of the state variable estimate \hat{X}ₜ⁻ and the error covariance estimate Pₜ⁻ indicates the predicted value.

Subsequently, the object tracking apparatus 100 may be configured to determine the Kalman gain K using a sensor predictor variable R (S103). The Kalman gain is used to set weights in response to updating a Kalman filter algorithm, and a method for determining the Kalman gain may be applied as a general method for determining the Kalman gain, detailed description will be omitted.

Accordingly, the object tracking apparatus 100 may be configured for estimating the final state variable \hat{X}ₜ through an update process of the Kalman filter algorithm using the state variable estimate \hat{X}ₜ⁻, the Kalman gain K, and the sensor measurement value Zₜ (S104). In the instant case, the sensor measurement value Zₜ may include a detecting result measured by the sensing device 200, for example, position and speed information of the object.

That is, the object tracking apparatus 100 may be configured to update the state variable estimate \hat{X}ₜ⁻ using the Kalman gain K and the sensor measurement value Zₜ, and the updated value may become the final state variable \hat{X}ₜ.

Furthermore, the object tracking apparatus 100 may be configured to perform an update process of the Kalman filter using the error covariance prediction value Pₜ⁻ and the Kalman gain K (S105), outputting the final error covariance Pₜ. That is, the object tracking apparatus 100 may be configured to update the predicted error covariance Pₜ⁻ to the final error covariance Pₜ using the Kalman gain K.

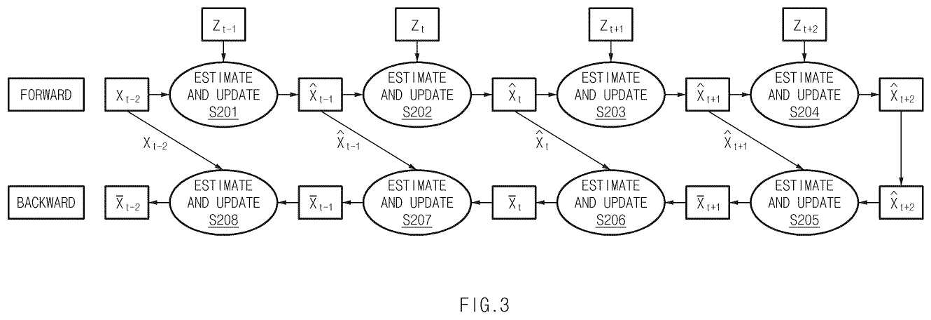

A process in FIG. 2 shows a basic structure of estimating a state variables and an error covariance at a current time point t using information at a previous time point t−1, and a process of estimating a state variable and an error covariance in forward and backward temporal directions will be described with reference to FIG. 3 based on the present basic structure.

Final state variables in FIG. 2 may refer to the state variables \hat{X}ₜ₋₁, \hat{X}ₜ, \hat{X}ₜ₊₁, \hat{X}ₜ₊₂, X̅ₜ₊₁, X̅ₜ, X̅ₜ₋₁, and X̅ₜ₋₂ estimated at each time point in FIG. 3, respectively. However, there is a difference in that the state variable estimated in the forward direction is used in response to estimate the state variable in the backward direction, and thus object estimation accuracy may be further increased.

Hereinafter, a process in which the object tracking apparatus 100 of the present disclosure tracks an object by bidirectionally estimating state variables will be described in detail with reference to FIG. 3 to FIG. 5.

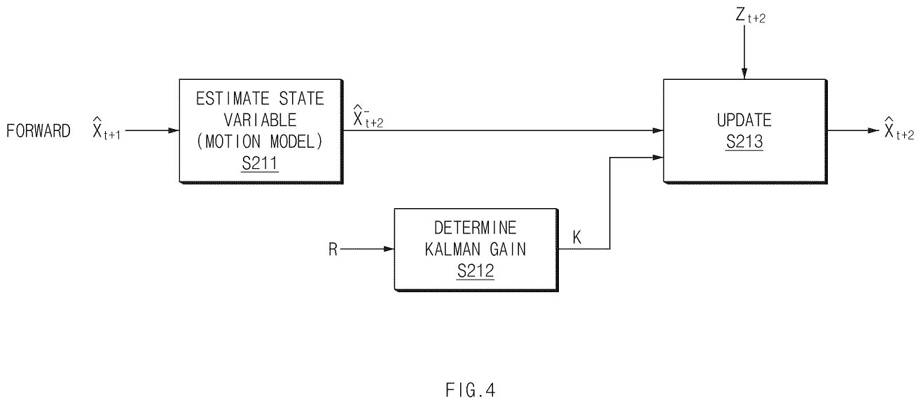

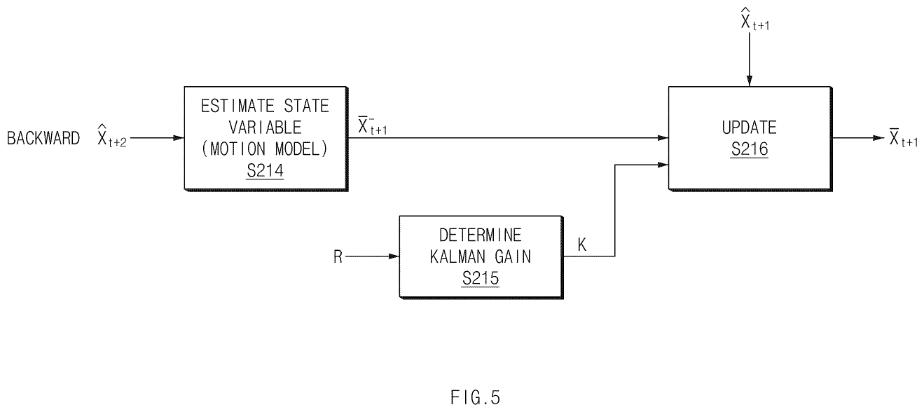

FIG. 3 illustrates a view for describing an example bidirectional state variable tracking process, and FIG. 4 illustrates a view for describing an example forward object tracking process in detail. FIG. 5 illustrates a view for describing an example backward object tracking process in detail.

Referring to FIG. 3, the object tracking apparatus 100 may be configured to first estimate a forward state variable \hat{X}ₜ₋₁ at a second time point t−1 using information Xₜ₋₂ at a first time point t−2 in the forward direction (S201), to estimate the forward state variable \hat{X}ₜ at a third time point t using the forward state variable \hat{X}ₜ₋₁ at the second time point t−1 (S202), to estimate the forward state variable \hat{X}ₜ₊₁ at a fourth time point t+1 using the forward state variable \hat{X}ₜ at the third time point t (S203), and to estimate the forward state variable \hat{X}ₜ₊₂ at a fifth time point t+2 using the forward state variable \hat{X}ₜ₊₁ at the fourth time point t+1 (S204).

FIG. 4 shows the process of S204 in response to estimating state variable in the forward direction in more detail. Referring to FIG. 4, the object tracking apparatus 100 may be configured to first estimate the forward state variable \hat{X}ₜ₊₂⁻ at the fifth time point t+2 using the forward state variable \hat{X}ₜ₊₁ at the fourth time point t+1 (S211), to determine the Kalman gain K (S212), to update the forward state variable \hat{X}ₜ₊₂⁻ at the fifth time point t+2, which is first estimated at the fifth time point, using the sensor measurement value Zₜ₊₂ at the fifth time point t+2 (S213), and to finally estimate the state variable \hat{X}ₜ₊₂ at the fifth time point t+2. FIG. 4 shows the process of estimating the forward state variable at the fifth time point using the forward state variable at the fourth time point t+1, but the forward estimation process of the state variable at each time point is the same as in FIG. 4.

Accordingly, the object tracking apparatus 100 may be configured to re-estimate the state variable in the backward direction.

That is, the object tracking apparatus 100 may be configured for estimating the backward state variable X̅ₜ₊₁ at the fourth time point t+1 by use of the forward state variable \hat{X}ₜ₊₂ at the fifth time point t+2 and the forward state variable X̅ₜ₊₁ at the fourth time point t+1 (S205). Furthermore, the object tracking apparatus 100 may be configured for estimating the backward state variable X̅ₜ at the third time point t by use of the backward state variable X̅ₜ₊₁ at the fourth time point t+1 and the forward state variable \hat{X}ₜ at the third time point t (S206), to estimate the backward state variable X̅ₜ₋₁ at the second time point t−1 by use of the backward state variable X̅ₜ at the third time point t and the forward state variable \hat{X}ₜ₋₁ at the second time point t−1 (S207), and to estimate the backward state variable X̅ₜ₋₂ at the first time point t−2 by use of the backward state variable X̅ₜ₋₁ and the initial state variable Xₜ₋₂ at the first time point t−2 (S208).

In the instant case, in FIG. 5, the object tracking apparatus 100 may be configured to first estimate the forward state variable X̅ₜ₊₁⁻ at the fourth time point t+1 using the forward state variable \hat{X}ₜ₊₂ at the fifth time point t+2 (S214), and then determine a Kalman gain (S215), to update the forward state variable X̅ₜ₊₁⁻ at the first estimated fourth time point t+1 by use of the forward state variable \hat{X}ₜ₊₁ at the fourth time point t+1 instead of the Kalman gain and the sensor measurement value Zₜ₊₁ at the fourth time point t+1 (S216), and to finally estimate the forward state variable X̅ₜ₊₁ at the fourth time point t+1 (S216).

FIG. 5 shows the process of estimating the backward state variable at the fourth time point using the forward state variable at the fifth time point t+2 in the backward direction, but the backward estimation process of the state variable at each time point is the same as in FIG. 5.

Furthermore, in FIG. 3 to FIG. 5, a two-way estimation process of error covariance is not illustrated, but in response to a case of bidirectionally estimating the error covariance, the error covariance may be estimated as in the basic structure of FIG. 2.

However, to further increase the accuracy of object tracking, like the state variable estimation in FIG. 3, the error covariance estimated in the forward direction may be used to estimate the error covariance in the backward direction.

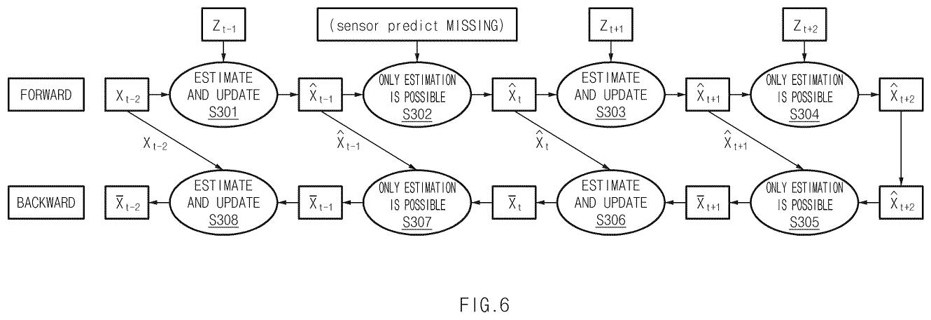

FIG. 6 illustrates a view for describing an example of performing compensation through backward tracking in response that a sensor measurement value is missing while forward tracking is performed during object tracking.

Referring to FIG. 6, the object tracking apparatus 100 may be configured for estimating the forward state variable \hat{X}ₜ₋₁ at the second time point t−1 using the initial state variable information Xₜ₋₂ at the first time point t−2 (S301), to estimate the forward state variable \hat{X}ₜ at the third time point t using the forward state variable \hat{X}ₜ₋₁ at the second time point t−1 (S302), to estimate the forward state variable \hat{X}ₜ₊₁ at the fourth time point t+1 using the forward state variable \hat{X}ₜ at the third time point t (S303), and to estimate the forward state variable \hat{X}ₜ₊₂ at the fifth time point t+2 using the forward state variable \hat{X}ₜ₊₁ at the fourth time point t+1 (S304). In the instant case, in step S302, the sensor measurement value Zₜ is missing, so there may be cases where the update process cannot be performed and the prediction process is performed. For example, in FIG. 2, the prediction process of S101 was performed, but the sensor measurement value is not input, so that the update process of S104 is not performed, and the final output value becomes the state variable \hat{X}ₜ⁻, which is the output value of the prediction process of S101.

In the instant case, in the next step S303, the state variable \hat{X}ₜ⁻ becomes the input value, so inaccurate information may continue to be accumulated and reflected in the next step.

However, the object tracking apparatus 100 may be configured to minimize a problem of such errors by reflecting the state variables estimated in the forward direction and re-estimating the state variables in the backward direction.

That is, the object tracking apparatus 100 may be configured for estimating the backward state variable X̅ₜ₊₁ at the fourth time point t+1 by use of the forward state variable \hat{X}ₜ₊₂ at the fifth time point t+2 and the forward state variable \hat{X}ₜ₊₁ at the fourth time point t+1 (S305). Furthermore, the object tracking apparatus 100 may be configured for estimating the backward state variable X̅ₜ at the third time point t by use of the backward state variable X̅ₜ₊₁ at the fourth time point t+1 and the forward state variable \hat{X}ₜ at the third time point t (S306), to estimate the backward state variable X̅ₜ₋₁ at the second time point t−1 by use of the backward state variable X̅ₜ at the third time point t and the forward state variable \hat{X}ₜ₋₁ at the second time point t−1 (S307), and to estimate the backward state variable X̅ₜ₋₂ at the first time point t−2 by use of the backward state variable X̅ₜ₋₁ and the initial state variable Xₜ₋₂ at the first time point t−2 (S308).

Accordingly, according to an exemplary embodiment of the present disclosure, even though an error occurs in response to tracking an object in the forward direction, by re-tracking it in the backward direction, an impact of errors may be minimized, improving object tracking performance.

Furthermore, according to an exemplary embodiment of the present disclosure, it may be possible to improve the object tracking performance by reflecting results obtained by estimating it in the forward direction at each step and re-tracking it rather than simply tracking it forward and backward.

Accordingly, after estimating the state variables in both directions, the object tracking apparatus 100 may be configured to output a variable which may be measured by a sensor among the estimated state variables X as an output value Y. For example, the state variables X may include velocity, acceleration, angular velocity, position information, etc., and among these state variables, the position information, which is one of the variables which may be measured by a sensor, may be output as the output value Y. The output value Y may include a forward output value Y_{forward} output using a forward state variable and a backward output value Y_{backward} output using a backward state variable. Accordingly, the object tracking apparatus 100 may be configured to output the final output value Y_{pred} using the forward output value Y_{forward} and the backward output value Y_{pred}.

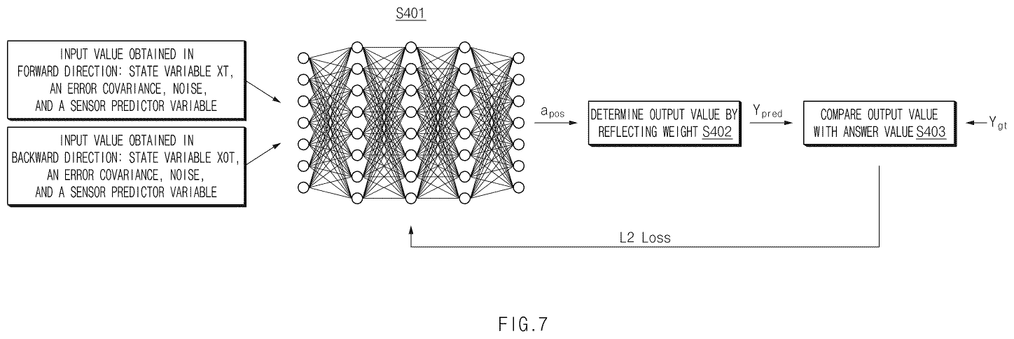

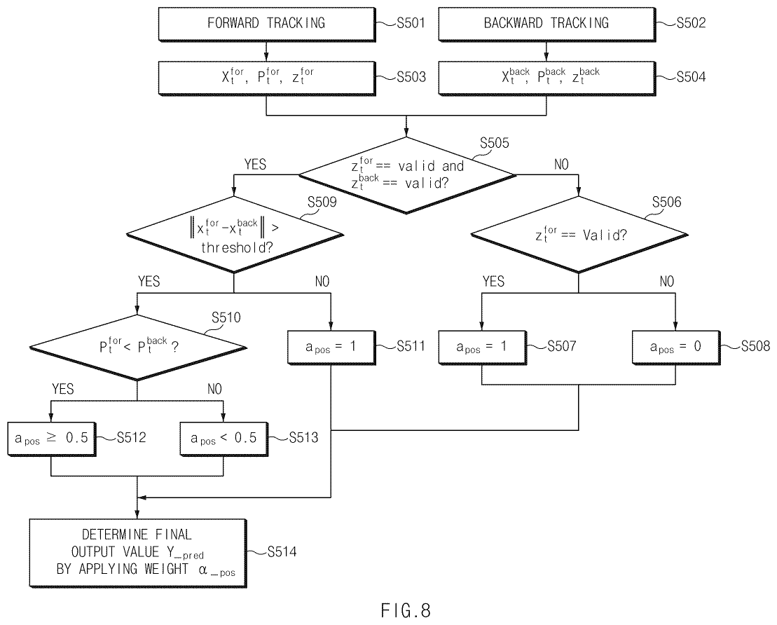

Hereinafter, a method of determining a final object tracking output value Y_{pred} using a bidirectional tracking result according to an exemplary embodiment of the present disclosure will be described in detail with reference to FIG. 7 and FIG. 8. FIG. 7 illustrates a view for describing an example process of determining a final object tracking output value Y_{pred} using a bidirectional tracking result, and FIG. 8 illustrates a view for describing an example process of determining a final object tracking output value Y_{pred} using a bidirectional tracking result.

Hereinafter, it is assumed that the object tracking apparatus 100 of FIG. 1 is configured to perform a process of FIG. 7. Furthermore, in the description of FIG. 7, operations described as being performed by a device may be understood as being controlled by the processor 140 of the object tracking apparatus 100. In following exemplary embodiments of the present disclosure, operations of steps S501 to S514 may be performed sequentially, but are not necessarily performed sequentially. For example, an order of each operation may be changed, and at least two operations may be performed in parallel.

Referring to FIG. 7, the object tracking apparatus 100 may be configured to learn by inputting a forward input value obtained in the forward tracking process of FIG. 3 and a backward input value obtained in a backward tracking process into a deep learning model, to determine the weight αₚₒₛ to be applied to the forward and backward output values (S401). In the instant case, the forward input value obtained in the forward tracking process and the backward input value obtained in the backward tracking process may include a state variable Xt, an error covariance, noise, and a sensor predictor variable. The object tracking apparatus 100 may be configured to determine the final output value Y_{pred} by reflecting a weight αₚₒₛ on the forward output value determined using the forward state variable and the backward output value determined using the backward state variable (S402). A deep learning model may be learned using variables of the Kalman filter as input thereof, and more accurate output values may be determined by implicitly learning correlation between variables.

A formula for determining the final output value Y_{pred} is as shown in Equation 1 below.

$${Y}_{pred} = {α}_{pos} \cdot {Y}_{forward} + ( 1 - {α}_{pos} ) \cdot {Y}_{backward} \qquad ( Equation 1 )$$

Y_{forward}, which is the forward output value, may be a value which may be output by a sensor among values of the state variable Xₜ estimated during forward tracking. Y_{backward}, which is the backward output value, may be a value which may be output by a sensor among the values of the state variable Xₜ estimated during backward tracking.

Furthermore, αₚₒₛ may be a weight determined in a deep learning model and may be expressed as Equation 2 below, and the weight may include an x-axis weight «, αₓ, y-axis weight α_{y}, and a z-axis weight α_{z}.

$${α}_{pos} = \{ \begin{matrix}{α}_{x} \\ {α}_{y} \\ {α}_{z}\end{matrix} \} \qquad ( equation 2 )$$

Accordingly, the object tracking apparatus 100 may be configured to improve accuracy by comparing the determined output value Y_{pred} with a previously known correct answer value Y_{gt} and re-inputting a difference L2 Loss therebetween into the deep learning model to learn it (S403).

$$L 2 Loss = \sqrt{{( {Y}_{pred} - {Y}_{gt} )}^{2}} \qquad ( Equation 3 )$$

Referring to FIG. 8, the object tracking apparatus 100 may be configured to determine whether a sensor measurement value zₜ^{for} obtained during forward tracking and a sensor measurement value zₜ^{back} obtained during backward tracking are valid values (S505) in response that result values obtained in the forward tracking process (S501) (forward state variable Xₜ^{for}, forward error covariance Pₜ^{for}, forward sensor measurement value zₜ^{for}) and result values obtained in the reverse tracking process (S502) (backward state variable Xₜ^{back}, backward error covariance Pₜ^{back}, and backward sensor measurement value zₜ^{back}) are respectively input into the deep learning model (S503 and S504). Herein, the object tracking apparatus 100 may be configured to determine that a sensor measurement value is invalid in response that the sensor measurement value zₜ^{for}, zₜ^{back} does not exist, that is, a case where the sensor measurement value zₜ^{for}, zₜ^{back} is not input due to a sensor failure, etc.

In response that at least one of the sensor measurement values zₜ^{for}, zₜ^{back} is not valid, the object tracking apparatus 100 may be configured to determine whether the forward sensor measurement value zₜ^{for}) is valid (S506).

The object tracking apparatus 100 may be configured to determine the weight αₚₒₛ to be 1 in response that the forward sensor measurement zₜ^{for} is valid (S507) and determine the weight αₚₒₛ to be 0 in response that the forward sensor measurement value zₜ^{for} is not valid (S508), to determine the final output value Y_{pred} by applying the determined weight to the Equation 1.

Meanwhile, in step S505, sensor measurement value (zₜ^{for}, zₜ^{back}) are all valid, the object tracking apparatus 100 may be configured to determine whether a difference between the forward state variable Xₜ^{for} and the backward state variable Xₜ^{back} is greater than a predetermined threshold (S509).

In response that difference between the forward state variable Xₜ^{for} and the backward state variable Xₜ^{back} is equal to or smaller than a predetermined threshold, the object tracking apparatus 100 may be configured to determine the weight αₚₒₛ to be 1 (S511) and apply the determined weight αₚₒₛ=1) to Equation 1 to determine the final output value Y_{pred} (S514).

In response that the difference between the forward state variable Xₜ^{for} and the backward state variable Xₜ^{back} is greater than the predetermined threshold, the object tracking apparatus 100 may be configured to determine whether a forward error covariance Pₜ^{for} is smaller than a backward error covariance Pₜ^{back} (S510). That is, the object tracking apparatus 100 may be configured to reexamine the error covariance in response that there is a large difference between the forward and backward output values.

The object tracking apparatus 100 may be configured to determine the weight αₚₒₛ to be greater than or equal to a predetermined value (A) (e.g., 0.5) in response that the forward error covariance Pₜ^{for} is smaller than the backward error covariance Pₜ^{back} (S512) and determine that the weight αₚₒₛ is smaller than the predetermined value (A) (e.g., 0.5) in response that the forward error covariance Pₜ^{for} is greater than the backward error covariance Pₜ^{back} (S513), to determine the final output value Y_{pred} by applying the determined weight αₚₒₛ to Equation 1 described above (S514). Accordingly, the object tracking apparatus 100 control a vehicle based on the the final output value Y_{pred}.

Accordingly, according to an exemplary embodiment of the present disclosure, the weight αₚₒₛ may be determined by use of the forward tracking result and the backward tracking result as input thereof to the deep learning model and the final output value Y_{pred} may be outputted by applying the weight to the forward tracking result and the backward tracking result, further increasing the accuracy of the final output value.

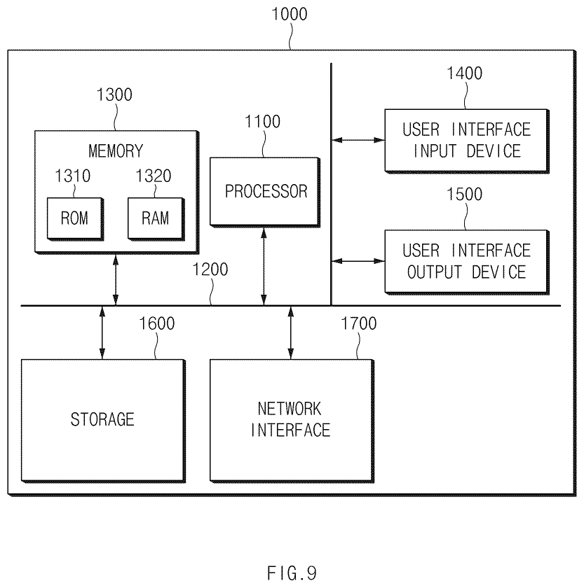

FIG. 9 illustrates an example computing system.

Referring to FIG. 9, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device which is configured to perform processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An object tracking apparatus comprising:
a processor configured for estimating a state variable of an object for each time point in a first direction in a flow of time, and estimating the state variable for each time point in a second direction which is opposite to the first direction in the flow of time, and for estimating the state variable of the object in the second direction for each time point using a result value estimated in the first direction; and
a storage configured to store data and algorithms driven by the processor.

2. The object tracking apparatus of claim 1, wherein the processor is further configured:
to estimate the state variable of the object at a second time point using the state variable of the object at a first time point and a sensor measurement value at the first time point in response to the estimating the state variable of the object in the first direction, and
to estimate the state variable of the object at the first time point in the second direction using the state variable of the object at the second time point and the state variable of the object at the first time point estimated in the first direction in response to the estimating the state variable of the object in the second direction.

3. The object tracking apparatus of claim 1,
wherein the first direction includes a forward direction from a previous time to a future time in the flow of time, and
wherein the second direction includes a backward direction from the future time to the previous time in the flow of time.

4. The object tracking apparatus of claim 3,
wherein the state variable includes a forward state variable and a backward state variable,
wherein the processor is further configured:
to estimate the forward state variable at a second time point using the forward state variable at a first time point and a sensor measurement value at the first time point,
to estimate the forward state variable at a third time point using the forward state variable at the second time point and the sensor measurement value at the second time point,
to estimate the backward state variable at the second time point using the forward state variable at the third time point and the forward state variable at the second time point, and
to estimate the backward state variable at the first time point using the backward state variable at the second time point and the forward state variable at the first time point.

5. The object tracking apparatus of claim 3,
wherein the state variable includes a forward state variable and a backward state variable,
wherein the processor is further configured:
to input the forward state variable at a first time point into a motion model to predict the forward state variable at a second time point, and
to update the forward state variable at the second time point using a Kalman gain and a sensor measurement value at the second time point.

6. The object tracking apparatus of claim 1, wherein the processor is configured for estimating an error covariance for each time point in the first direction in the flow of time, and for estimating the error covariance for each time point in the second direction which is opposite to the first direction in the flow of time.

7. The object tracking apparatus of claim 6, wherein the processor is further configured:
to estimate the error covariance at a second time point using the error covariance at a first time point and a system noise, and
to update the error covariance at the second time point using a Kalman gain.

8. The object tracking apparatus of claim 1, wherein the processor is further configured to determine a weight by applying an input value obtained in the first direction and an input value obtained in the second direction to a deep learning algorithm.

9. The object tracking apparatus of claim 8, wherein the input value obtained in the first direction and the input value obtained in the second direction include at least one of a state variable of the object, error void, noise, sensor predictor variable, or a combination thereof.

10. The object tracking apparatus of claim 8, wherein the processor is further configured:
to determine an output value in the first direction using the state variable of the object obtained in the first direction, and
to determine the output value in the second direction using the state variable of the object obtained in the second direction.

11. The object tracking apparatus of claim 10, wherein the processor is further configured to determine a final output value by reflecting a weight on the output value in the first direction and the output value in the second direction.

12. The object tracking apparatus of claim 11, wherein the processor is further configured to compare the final output value with a previously known correct answer to receive feedback on a difference therebetween.

13. The object tracking apparatus of claim 8, wherein the processor is further configured:
to determine whether a sensor measurement value obtained in the first direction and a sensor measurement value obtained in the second direction among the input value obtained in the first direction and the input value obtained in the second direction are input, and
in response that at least one of the sensor measurement value obtained in the first direction or the sensor measurement value obtained in the second direction is not input, to determine whether the sensor measurement value obtained in the first direction has been input.

14. The object tracking apparatus of claim 13, wherein the processor is further configured:
to set the weight to 1 in response that the sensor measurement value obtained in the first direction is input, and
to set the weight to 0 in response that the sensor measurement value obtained in the first direction is not input.

15. The object tracking apparatus of claim 13, wherein the processor is configured,
in response that the sensor measurement value obtained in the first direction and the sensor measurement value obtained in the second direction are input,
to determine whether a difference between the state variable obtained in the first direction and the state variable obtained in the second direction among the input value obtained in the first direction and the input value obtained in the second direction is greater than a predetermined threshold.

16. The object tracking apparatus of claim 15, wherein the processor is configured to set the weight to 1 in response that the difference between the state variable obtained in the first direction and the state variable obtained in the second direction is smaller than or equal to the predetermined threshold.

17. The object tracking apparatus of claim 16, wherein the processor is configured,
in response that the difference between the state variable obtained in the first direction and the state variable obtained in the second direction is greater than the predetermined threshold, to determine whether an error covariance obtained in the first direction between the input value obtained in the first direction and the input value obtained in the second direction is smaller than an error covariance obtained in the second direction.

18. The object tracking apparatus of claim 17, wherein the processor is further configured:
to set the weight to 0.5 or more than 0.5 in response that the error covariance obtained in the first direction is smaller than the error covariance obtained in the second direction, and
to the weight to less than 0.5 in response that the error covariance obtained in the first direction is greater than or equal to the error covariance obtained in the second direction.

19. An object tracking method comprising:
estimating, by a processor, a state variable of an object for each time point in a first direction in a flow of time; and
estimating, by the processor, the state variable for each time point in a second direction which is opposite to the first direction in the flow of time, and estimating, by the processor, the state variable of the object in the second direction for each time point using a result value estimated in the first direction.

20. The object tracking method of claim 19, further including:
determining, by the processor, a weight by applying an input value obtained in the first direction and an input value obtained in the second direction to a deep learning algorithm;
determining, by the processor, an output value in the first direction using the state variable of the object obtained in the first direction;
determining, by the processor, an output value in the second direction using the state variable of the object obtained in the second direction; and
determining, by the processor, a final output value by reflecting a weight on the output value in the first direction and the output value in the second direction.
